(19) United States
(12) Patent Application Publication
(10) Pub. No.: US 2024/0054838 A1
(43) Pub. Date: Feb. 15, 2024

(54) Method and System for Device Access Control

(71) Applicant: APPLE INC., Cupertino, CA (US)

(72) Inventor: Kevin M. Lynch, Woodside, CA (US)

(21) Appl. No.: 18/222,657

(22) Filed: Jul. 17, 2023

Related U.S. Application Data
(60) Provisional application No. 63/396,803, filed on Aug. 10, 2022.

(51) Int. Cl. G07C 9/28; G07C 9/22; G06F 3/16; G06F 3/01

(52) U.S. Cl. CPC G07C 9/28; G07C 9/22; G06F 3/167; G06F 3/017; G07C 2209/63

(57) ABSTRACT

A method includes obtaining sensor information from a sensor system, wherein the sensor system senses exterior surroundings of an access-controlled interior space. The method also includes determining that a person is located outside an entry to the access-controlled interior space, using the sensor information, determining that the person is authorized to enter the access-controlled interior space, using the sensor information, and detecting an intention to enter the access-controlled interior space by the person. In response to determining that the person is located near the access-controlled interior space, the method includes determining that the person is authorized to enter the access-controlled interior space, and detecting the intention to enter the access-controlled interior space, providing access to the access-controlled interior space.

### CROSS-REFERENCE TO RELATED APPLICATIONS

This application claims the benefit of and priority to U.S. Provisional Application No. 63/396,803, filed on Aug. 10, 2022, the content of which is hereby incorporated by reference herein in its entirety for all purposes.

### FIELD

The present disclosure relates generally to the field of device access control.

### BACKGROUND

Doors and other entryways are known that are unlocked based on presence of a device near the door.

### SUMMARY

One aspect of the disclosure is a method that includes obtaining sensor information from a sensor system, wherein the sensor system senses exterior surroundings of an access-controlled interior space. The method also includes determining that a person is located outside an entry to the access-controlled interior space, using the sensor information, determining that the person is authorized to enter the access-controlled interior space, using the sensor information, and detecting an intention to enter the access-controlled interior space by the person. In response to determining that the person is located near the access-controlled interior space, determining that the person is authorized to enter the access-controlled interior space, and detecting the intention to enter the access-controlled interior space, the method includes providing access to the access-controlled interior space.

In some implementations, detecting the intention to enter the access-controlled interior space comprises determining an angle of approach of the person with respect to the access-controlled interior space and a speed of approach of the person with respect to the access controlled interior space. In some implementations, detecting the intention to enter the access-controlled interior space comprises determining a geolocation of the access-controlled interior space. In some implementations, detecting the intention to enter the access-controlled interior space comprises determining a degree of correlation between presence near the access-controlled interior space and intent to enter the access-controlled interior space according to a current location of the access-controlled interior space. In some implementations, detecting the intention to enter the access-controlled interior space comprises detecting a spoken command. In some implementations, detecting the intention to enter the access-controlled interior space comprises detecting a gesture made by the person. In some implementations, detecting the intention to enter the access-controlled interior space comprises detecting contact with a portion of the access-controlled interior space. In some implementations, detecting the intention to enter the access-controlled interior space comprises receiving, from a device associated with the person, a command to heat or cool a system of the access-controlled interior space.

Another aspect of the disclosure is a non-transitory computer-readable storage device including program instructions executable by one or more processors that, when executed, cause the one or more processors to perform operations. The operations include obtaining sensor information from a sensor system, wherein the sensor system senses exterior surroundings of an access-controlled interior space. The operations also include determining that a person is located outside an entry to the access-controlled interior space, using the sensor information, determining that the person is authorized to enter the access-controlled interior space, using the sensor information, and detecting an intention to enter the access-controlled interior space by the person. In response to determining that the person is located near the access-controlled interior space, determining that the person is authorized to enter the access-controlled interior space, and detecting the intention to enter the access-controlled interior space, the operations include providing access to the access-controlled interior space.

Another aspect of the disclosure is an apparatus that includes a memory and one or more processors that are configured to execute instructions that are stored in the memory. The instructions, when executed, cause the one or more processors to obtain sensor information from a sensor system, wherein the sensor system senses exterior surroundings of an access-controlled interior space, determine that a person is located outside an entry to the access-controlled interior space, using the sensor information, determine that the person is authorized to enter the access-controlled interior space, using the sensor information, and detect an intention to enter the access-controlled interior space by the person. In response to determining that the person is located near the access-controlled interior space, determining that the person is authorized to enter the access-controlled interior space, and detecting the intention to enter the access-controlled interior space, the instructions cause the one or more processors to provide access to the access-controlled interior space.

### BRIEF DESCRIPTION OF THE DRAWINGS

FIG. 1 is a block diagram of a system that includes an access-controlled interior space.

FIG. 2 is a block diagram of an implementation in which the access-controlled interior space is defined by a structure.

FIG. 3 is a block diagram that shows a process for providing access to the access-controlled interior space.

FIG. 4 is a block diagram of an implementation in which the access-controlled interior space is defined by a device.

FIG. 5 is a block diagram that shows a computing device according to an example implementation.

### DETAILED DESCRIPTION

The disclosure herein relates to providing access to an access-controlled interior space of a structure based on sensor information, and allows for use of contextual and behavioral information when determining whether and how the structure should respond to the presence of a person near the access-controlled interior space. Providing access to the access-controlled interior space of the structure may include unlocking a door of the structure and/or automatically opening the door of the structure.

As one example, presence of a key fob or other device that signifies authorization to enter the access-controlled interior space may be insufficient to cause the structure to respond by providing access, because this circumstance alone does not necessarily evidence intention to enter the structure. Instead, sensor information may be analyzed to identify evidence of an intention, by the person who is located near the access-controlled interior space, to enter the access-controlled interior space. For example, the sensor information may include observations of an exterior environment around the access-controlled interior space. This prevents the structure from responding to the presence of the person erroneously when there is no intention to enter the access-controlled interior space.

As another example, when a key fob or other device that signifies authorization to enter the access-controlled interior space is not present near the access-controlled interior space, sensor information may be analyzed to determine an identity of the person who is located near the access-controlled interior space, and to identify evidence of an intention, by the person who is located near the access-controlled interior space, to enter the access-controlled interior space. If it is determined, based on the identity of the person, that they are authorized to enter the access-controlled interior space, and it is also determined that the person intends to enter the access-controlled interior space, access to the access-controlled interior space can be provided to the person who is located near the access-controlled interior space.

As another example, when a key fob or other device that signifies authorization to enter the access-controlled interior space is not present near the access-controlled interior space, sensor information may be analyzed to identify evidence of an intention, by the person who is located near the access-controlled interior space, to enter the access-controlled interior space. If it is determined that the person intends to enter the access-controlled interior space, the structure may contact an authorized user of the access-controlled interior space in order to determine whether to provide access to the person who is located near the access-controlled interior space.

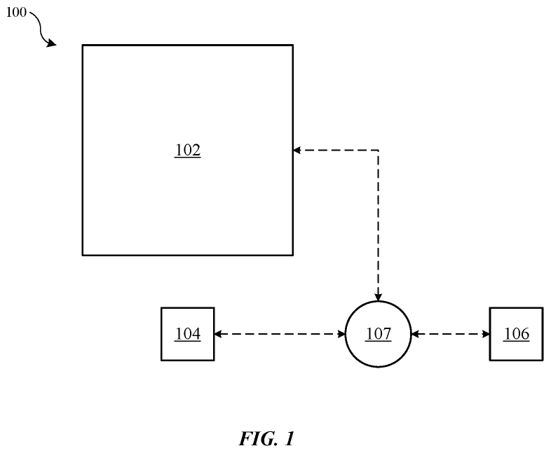

FIG. 1 is a schematic diagram of a system 100 that includes an access-controlled interior space 102, a user device 104, and a service 106. The access-controlled interior space 102, the user device 104, and the service 106 are configured to communicate with each other, for example, by transmission of signals and/or data, using a network 107. The network 107 is a communications network that allows wired and/or wireless communications connections to be established between devices. The network 107 may be or include local area networks, the Internet, and/or direct communications using any type of short range communications system.

The access-controlled interior space 102 is an area that is separated from a surrounding environment by a structure that defines the extents of the access-controlled interior space 102, and includes a means for entry and exit, such as a door, as will be described with respect to specific implementations. Hardware and software components are associated with the access-controlled interior space 102 in order to implement access-control functions, as will be described herein, and references herein to the access-controlled interior space 102 may refer to the physical space in combination with the hardware and/or software components that implement the access-control functionality.

In the illustrated implementation, presence of the user device 104 near the access-controlled interior space 102 signifies presence of a person who is authorized to use the access-controlled interior space 102. In other implementations, as will be described, presence of the user device 104 is optional and authorization and/or intention to use the access-controlled interior space 102 may be determined in other ways, such as by using sensors.

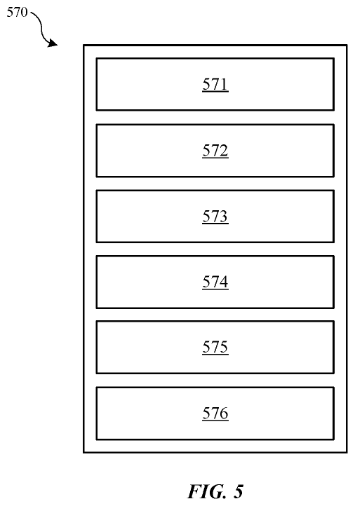

The user device 104 may be a smart cellular phone, a key fob, or another type of electronic device that can be carried by a user. As an example, the user device 104 may be able to receive information from a user, provide information to the user, and communicate with the access-controlled interior space 102 and/or the service 106. The user device 104 may be associated with an authorized user of the access-controlled interior space 102. The user device 104 may be associated with a person who is located near the access-controlled interior space 102, and who may or may not be authorized to use the access-controlled interior space 102. In some implementations, multiple devices equivalent to the user device 104 are used, such as a first device associated with an authorized user of the access-controlled interior space 102 and a second device that is associated with a person who is located near the access-controlled interior space 102. In some implementations, the user device 104 employs exemplary computing device 570 described with reference to FIG. 5, below.

The service 106 may communicate with the access-controlled interior space 102 and the user device 104 to facilitate certain aspects of use of the access-controlled interior space 102 by a user who is associated with the user device 104, as will be explained in detail herein. As an example, the service 106 may be configured to send and receive information, commands, requests, to and from the access-controlled interior space 102 and the user device 104. As an example, the service 106 may be configured to make determinations relating to the access-controlled interior space 102 and/or the user device 104. The determinations may be made by the service 106 in response to requests received from the access-controlled interior space 102 and/or the user device 104, in response to receiving information that indicates that a condition is satisfied, in response to passage of a time period (e.g., having a predetermined duration or a duration that is calculated based on information received by the service 106), and so forth.

In some implementations, the service 106 may store a user profile for the user who is associated with the user device 104. The user profile may be used to determine whether the user is authorized to use the access-controlled interior space 102, by indicating that the user is an owner of the access-controlled interior space 102 or has been granted permission to use the access-controlled interior space 102. The user profile may store additional information, such as preferences. Gathering and storage of information in a user profile or other form is only performed with consent from the user, and is optional.

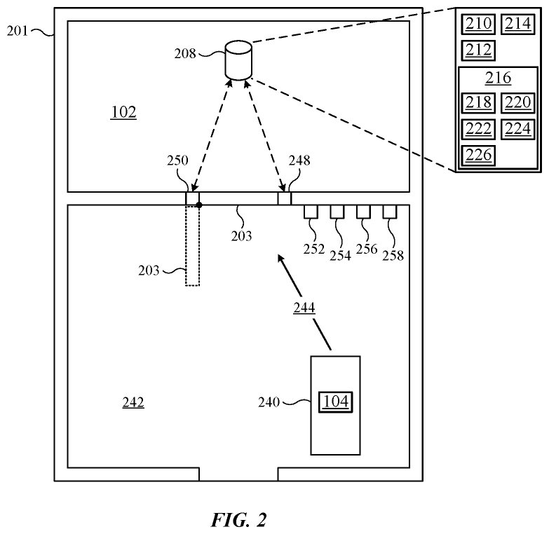

FIG. 2 is a schematic illustration of an implementation of the system 100, in which the access-controlled interior space 102 is defined by a structure 201. In the illustrated implementation, the structure 201 is a building, such as a residential building or an office building. The access-controlled interior space 102 is defined in the structure, for example, in the form of a room, such as a bedroom, a bathroom, or an office. Alternatively, the access-controlled interior space 102 could be the entire interior of a building, office suite, residence, so forth. Thus, the access-controlled interior space 102 may be defined by walls or other structural components that are included in the structure 201.

The structure 201 is configured so that persons can enter the access-controlled interior space 102 and/or so that items may be placed inside the access-controlled interior space 102, such as by inclusion of a door 203 that is movable between a closed position and an open position to selectively provide access to the access-controlled interior space 102. A control device 208 is associated with the structure 201 and with the access-controlled interior space 102. The control device 208 includes components that are configured to perform or support functions of the system 100, such as determining whether to provide access to the access-controlled interior space 102 and providing access to the access-controlled interior space 102, such as by moving the door 203 between the closed and open positions.

Examples of components that may be included in the control device 208 include a sensor system 210, a human interface device (HID) interface 212, a communications system 214, and an entry control system 216. The components of the control device 208 may be integrated into the structure 201 and/or may be included in a separate device, which may be, as examples, a dedicated access control device, or a multi-function device, such as a smart home control system, a smart speaker, a laptop computer, a tablet computer, so forth. The components are electrically interconnected, either wired or wirelessly, to allow transmission of signals, data, commands, etc., between them.

The sensor system 210 includes one or more sensor components that are able to collect information that describes an environment 242 inside and/or around the structure 201, conditions inside the access-controlled interior space 102, and/or other information, in order to support functions of the access-controlled interior space 102. For example, the sensor system 210 may senses exterior surroundings (e.g., the environment 242) of the access-controlled interior space 102 in order to determine whether and how to provide access to the access-controlled interior space 102. The information output by the sensor system 210 may be in the form of sensor signals that represent measurements and/or observations. Exemplary sensor components in the sensor system 210 include imaging devices such as still cameras in the visible spectrum or the infrared spectrum, video cameras, Lidar or other depth sensors, Radar sensors, satellite positioning sensors, inertial measurement units, position sensors, angle sensors, speed sensors, torque sensors, force sensors, and so forth.

The HID interface 212 includes components that allow a user to interact with various system of the structure 201. The HID interface 212 includes input devices and output devices. Examples of HID interface 212 include display screens, touch-sensitive interfaces, gesture interfaces, audio output devices, voice command interfaces, buttons, knobs, so forth.

The communications system 214 allows signals carrying data to be transmitted from access-controlled interior space 102 to remote systems and/or to be received at the access-controlled interior space 102 from remote systems. Any suitable communications protocol and/or technology may be utilized to implement the communications system 214, such as cellular protocols. As an example, the communications system 214 allows real-time communications between the access-controlled interior space 102 and other devices or systems, such as the user device 104 and the service 106. Communications devices that are included in the communications system 214 may function as sensors from the sensor system 210. For example, a communication device from the communications system 214 may receive a signal that is emitted from an external device, such as the user device 104, thereby sensing that the external device is nearby (e.g., obtaining sensor information indicating that the external device is nearby), and optionally receiving information by a transmission from the external device that identifies the external device and/or identifies an identity of the user that is associated with the external device.

The entry control system 216 functions to determine whether to provide a person 240 with access to the access-controlled interior space 102. The person 240 may be located in the structure 201 or in the environment 242 around the access-controlled interior space 102. The person 240 may carry the user device 104. The person 240 may be moving (e.g., walking) in the structure 201 or the environment 242 according to a trajectory 244, for example, including an angle of approach and a speed of approach relative to the access-controlled interior space 102 of the structure 201 and/or with respect to the door 203 of the structure 201. The door 203 of the structure 201 may be locked and unlocked by a locking mechanism 248 (e.g., including an actuator that is controllable to lock and unlock the door 203) and which may be automatically opened and closed by a door movement mechanism 250 (e.g., including an actuator that is controllable to move the door 203 between a closed position, depicted in solid lines, and an open position, depicted in dotted lines). As will be described herein, the entry control system 216 may monitor the person 240 while the person 240 is located near the access-controlled interior space 102 of the structure 201 to determine whether and how to provide access to the structure 201. Components of the sensor system 210 and/or components from other systems of the structure 201 may be used by the entry control system 216 to obtain information regarding the person 240 and/or the environment 242 around the access-controlled interior space 102. As examples, the entry control system 216 may obtain information using a camera 252 (e.g., one or more cameras) that is configured to obtain images of the person 240 and/or the environment 242 around the access-controlled interior space 102, a communications device 254, a microphone 256 (e.g., one or more microphones and/or other audio input devices), and a touch sensor 258 (e.g., one or more touch sensors, such as capacitance-based touch sensors).

The entry control system 216 is configured to control whether and how to provide access to the access-controlled interior space 102 so that authorized persons who wish to use the access-controlled interior space 102 may enter it. For example, the entry control system 216 is configured to determine whether to unlock and/or automatically open the door 203. The door 203 may be unlocked by the entry control system 216 using the locking mechanism 248, such as by sending a command to the locking mechanism 248. The door 203 may be opened by the entry control system 216 using the door movement mechanism 250, such as by sending a command to the door movement mechanism 250. Thus, providing access to the access-controlled interior space 102 may include unlocking the door 203 and/or automatically opening the door 203 (e.g., by moving the door 203 of the structure 201 from a closed position to an open position).

As used herein, the term “door” is intended to encompass portions of the structure 201 that are able to open and close (e.g., are movable between a closed position and an open position) to allow access to the access-controlled interior space 102 of the structure 201. Thus, “doors” include, but are not necessarily limited to structures to permit persons to enter and exit the access-controlled interior space 102. Doors may incorporate a locking feature, such as the locking mechanism 248, meaning that access from the exterior of the structure 201 is mechanically restricted by inoperability of or lack of a user-operable entry mechanism, such as a door handle, when the door 203 is locked, and that access is provided, by permitting manual or automatic movement of the door 203, when the door 203 is unlocked.

The entry control system 216 includes a proximity detecting function 218, an identity detecting function 220, an authorization determining function 222, an intention detecting function 224, and an access determining function 226. As an example, the entry control system 216 may be implemented by one or more computing devices. In some implementations, the entry control system 216 employs exemplary computing device 570 described with reference to FIG. 5, below. The functions of the entry control system 216 may each be implemented in the form of computer program instructions that are stored by one or more computing devices of the entry control system 216, and which are executed by one or more computing devices of the entry control system 216 to cause performance of the operations that will be discussed herein with respect to each of the functions.

The sensor information used by the functions of the entry control system 216 may include signals and/or data generated by the sensors from the sensor system 210 that represent observations, by the sensors, of conditions in the access-controlled interior space 102 of the structure 201 or in the environment 242 around access-controlled interior space 102. The sensor information may also include signals and/or data from systems other than those explicitly included in the sensor system 210, to the extent that the information represents an observation of the environment 242 and is usable in the determinations made by the functions of the entry control system 216. Thus, sensor information from the sensor system 210 and/or from other systems of the structure 201 and the access-controlled interior space 102 may be used as a basis for the determinations made by the functions of the entry control system 216. In some circumstances, information from a single sensor may be used. In other circumstances, information from multiple sensors may be used in combination. As examples, sensor information from multiple sensors may be combined, for example, according to a rule, a weighting formula, a probability model, or other technique, to support execution of the functions of the entry control system 216.

The proximity detecting function 218 uses sensor information to determine whether the person 240 is located near the access-controlled interior space 102. The person 240 is considered to be located near the access-controlled interior space 102 when they are at a location relative to the access-controlled interior space 102 (e.g., relative to the door 203) that may be associated with a present intention to enter the access-controlled interior space 102. As an example, being located near the access-controlled interior space 102 may be defined as presence within a threshold distance of the access-controlled interior space 102, presence within a threshold distance of the door 203, presence in a room or other space where the door 203 of the access-controlled interior space 102 is present, presence in a defined outdoor space that is near the door 203, and so forth.

As one example of sensor information that can be used to determine whether the person 240 is present near the access-controlled interior space 102 (and/or near the door 203), the sensor information may include information that indicates the user device 104 that is associated with the person 240 is located near the access-controlled interior space 102. This information may be, for example, a signal from the user device 104. The signal may be received by a component that is associated with the communications system 214, such as a wireless networking receiver or another type of communications component. Alternatively, the signal from the user device 104 may be received by a different type of sensing component that is included in the sensor system 210. The signal from the user device 104 may be transmitted by the user device 104 to the control device 208 using a short range communications protocol, and this signal may be received by the communications device 254. The signal may be a direct transmission, or may be an indirect transmission using external wireless networking hardware. In some implementations, the signal from the user device 104 indicates that the user device 104 is within range of a sensor of the sensor system 210 (e.g., within communications range), and this may be considered sufficient basis for determining presence dependent on the range characteristics of the signal.

The sensor information indicating presence of the user device 104 may correspond to a high probability that the person 240 is located near the access-controlled interior space 102. As an example, the information indicating presence of the user device 104 may correspond to a higher probability that the person 240 is located near the access-controlled interior space 102 as compared to other types of information that are available for use in determining whether the person 240 is located near the access-controlled interior space 102. Thus, the presence of the person 240 near the access-controlled interior space 102 may be determined based at least in part on determining that the person 240 is located with a range of one or more sensors, such as sensors from the sensor system 210, and/or presence may be determined further based on the information contained in or associated with the signal. Determining that the person 240 is located near the access-controlled interior space 102 by the proximity detecting function 218 may include determining that the person 240 is located within a threshold distance of the access-controlled interior space 102 or the door 203. As one example, a signal received from the user device 104 may be interpreted to estimate distance. This estimate of distance may be based on signal strength, round trip communications response time, or other range determining techniques. Thus, determining that the person 240 is located near the access-controlled interior space 102 may include receiving a signal from the user device 104 that is associated with the person 240 who is located near the access-controlled interior space 102.

Determining that the person 240 is located near the access-controlled interior space 102 by the proximity detecting function 218 may include determining that the person 240 is located within a field of view of one or more cameras, such as the camera 252. As an example, one or more images that are captured by the camera 252 (e.g., one or more visible spectrum video and/or still cameras) may be analyzed to determine the presence of the person 240 using machine vision techniques, such as an object classifier that is implemented using a trained machine learning model.

The identity detecting function 220 of the entry control system 216 is configured to determine an identity of the person 240 that is located near the access-controlled interior space 102 using sensor information. The sensor information that is used by the identity detecting function 220 may be obtained by sensors that are associated with the sensor system 210 of the structure 201 or by a sensor associated with a different system of the structure 201. As one example, the sensor information that is used by the identity detecting function 220 may be received in a transmission to the control device 208 from a device that is associated with the person 240, such as the user device 104, where the received information identifies the person 240. Such information may be, as examples, a name of the person 240, a user identification code, or an authentication credential (e.g., a username/password combination or an authentication token). As another example, the sensor information provided to the identity detecting function 220 may include images, and determining the identity of the person 240 is performed using the images. The images may be obtained by the camera 252. The images are analyzed using machine vision techniques to determine the identity of the person 240 by comparison of the visual appearance of the person 240 in the images (e.g., the face of the person 240) to the visual appearance of the person 240 in previously supplied images of the person 240 (such images or information derived from such images having been previously obtained, stored, and/or made available to the identity detecting function 220 prior to a current instance of the person 240 approaching the access-controlled interior space 102, such as during a setup process). Thus, the identity detecting function 220 may determine the identity of the person 240 who is located near the access-controlled interior space 102 by recognizing the person 240 from one or more images.

The authorization determining function 222 is configured to determine whether the person 240 who is located near the access-controlled interior space 102 is authorized to use the access-controlled interior space 102. This determination may be made by the authorization determining function 222 using sensor information that is obtained by the sensor system 210 and/or other systems of the control device 208 and/or the structure 201. Determining whether the person 240 is authorized to use the access-controlled interior space 102 may be based one on the identity of the person 240 as determined by the identity detecting function 220. As an example, the identity of the person 240, as determined by the identity detecting function 220, may be compared to information that identifies authorized persons (e.g., a list of authorized persons, or a user profile that associated with the person 240 and includes an indication of authorization to use the access-controlled interior space 102), and the person 240 may be determined to be authorized or unauthorized based on the comparison. In some implementations, the authorization determining function 222 receives authorization information, such as a signal indicating authorization, a username password combination, biometric characteristics (e.g., facial recognition), or other information from the user device 104, and this information is compared to information that identifies authorized persons in order to determine whether the person 240 located near the access-controlled interior space 102 is authorized to use the structure 201. Thus, determining that the person 240 is authorized to use the access-controlled interior space 102 may include receiving a signal from the user device 104. The signal may be received using the communications device 254.

The user device 104 may automatically send the authorization information to the control device 208 when the user device 104 is located near the access-controlled interior space 102. In some implementations, the authorization information may be sent from the user device 104 to the control device 208 only when the user device 104 is in an unlocked state, in which some functionalities of the user device 104 have been made available for use by the person 240 as a result of an authentication process of the user device 104, as opposed to a locked state in which those functionalities are not available until the user device 104 is unlocked.

In response to receipt of the authorization information by the authorization determining function 222, this information is compared to information that identifies authorized persons in order to determine whether the person 240 located near the access-controlled interior space 102 is authorized to use the access-controlled interior space 102. Determining that the person 240 is authorized may be used as a signal in a determination as to whether and how to provide access to the access-controlled interior space 102, as will be discussed further.

In some implementations, the authorization determining function 222 may contact a known authorized user if the person 240 located near the access-controlled interior space 102 is not authorized or if authorization for the person 240 located near the access-controlled interior space 102 cannot be determined conclusively based on the sensor information that is available to the control device 208. For example, determining that the person 240 who is located near the access-controlled interior space 102 of the structure 201 is authorized to use the access-controlled interior space 102 of the structure 201 may include transmitting, to an authorized user of the control device 208, a request for access to the control device 208. The request may be transmitted using the communications device 254. The person 240 who is located near the access-controlled interior space 102 may subsequently be granted access to the access-controlled interior space 102 upon receipt, by the control device 208 of the access-controlled interior space 102, of a grant of access from the authorized user. In some implementations, a request for access to the access-controlled interior space 102 is only sent to the authorized user if the person 240 who is located near the access-controlled interior space 102 is not authorized to use the access-controlled interior space 102. In some implementations, transmitting the request to access is conditional on determining an intent to use the access-controlled interior space 102 as will be described with respect to the intention detecting function 224.

The request for access to the access-controlled interior space 102 may be transmitted from the control device 208 of the access-controlled interior space 102 to the user device 104 that is associated with the authorized user. Likewise, the grant of access to the access-controlled interior space 102 may be transmitted from the user device 104 that is associated with the authorized user to the control device 208 of the access-controlled interior space 102.

Information that identifies the person 240 who is located near the access-controlled interior space 102 is transmitted to the authorized user with request for access to the access-controlled interior space 102. This information may be or include the identity of the person 240, as determined by the identity detecting function 220. The request for access to the access-controlled interior space 102 may alternatively or additionally include an image obtained by the camera 252.

The intention detecting function 224 is configured to detect whether the person 240 who is located near the access-controlled interior space 102 has an intention (e.g., a present intention) to enter the access-controlled interior space 102. Thus, the intention detecting function 224 can detect an intention to enter the access-controlled interior space 102 by the person 240 who is located near the access-controlled interior space 102, or a lack of such intention.

The purpose of the intention detecting function 224 is to differentiate situations in which the person 240 is located near the access-controlled interior space 102 coincidentally, and without intention to enter and use it, from situations in which the person 240 is approaching the access-controlled interior space 102 because they intend to enter and use the access-controlled interior space 102. As an example, when the person 240 is simply passing by the access-controlled interior space 102 without intending to use the access-controlled interior space 102, the intention detecting function 224 uses contextual information to understand this lack of intention to use the access-controlled interior space 102.

The intention detecting function 224 can consider multiple signals, including sensor information received from the sensor system 210, and information obtained from other systems of the control device 208 and/or the structure 201. This information can be combined in manners previously described to judge intention, for example, using a rule, a formula, a probability model, or other technique. Some circumstances that are evaluated by the intention detecting function 224 may, by themselves, provide a sufficient basis for determining an intention or lack or intention to use the access-controlled interior space 102. Other circumstances that are evaluated by the intention detecting function 224 may be indicate a higher or lower likelihood that an intention to use the access-controlled interior space 102 exists, and information representing these circumstances can be combined with other information to judge intention.

In some implementations, the intention detecting function 224 can determine whether the person 240 intends to use the access-controlled interior space 102 based at least in part on the trajectory 244 of the person 240. The intention detecting function 224 is configured to evaluate whether the trajectory 244 of the person 240 is consistent with movement toward the access-controlled interior space 102 (e.g., including movement toward the door 203) for the purpose of entering it or otherwise interacting with it, such as by placing an item inside the access-controlled interior space 102. When the trajectory 244 of the person 240 is consistent with movement toward the access-controlled interior space 102, the intention detecting function 224 may interpret that as evidence that the person 240 intends to use the access-controlled interior space 102, and the intention detecting function 224 may interpret the trajectory 244 being inconsistent with movement toward the access-controlled interior space 102 as evidence that the person 240 does not intend to use the access-controlled interior space 102.

The trajectory 244 of the person 240 may be determined by using information from the sensor system 210. As one example, images obtained by the camera 252 may be analyzed to identify the person 240 and track their motion within the environment 242 (e.g., using machine vision based object detection and tracking techniques). As another example, the location of the person 240 with respect to the structure 201 may be monitored over time to determine the trajectory 244 of the person 240 based on location signals (e.g., geospatial coordinates determined using satellite positioning) obtained from the user device 104 (e.g., a smart phone or smart watch carried by the person 240). Multiple aspects of the trajectory 244 of the person 240 may be determined, tracked over time, and used as a basis for determining the intention of the person 240.

The intention detecting function 224 may be configured to determine whether the person 240 intends to enter the structure 201 based in part on the angle of approach of the person 240 with respect to the access-controlled interior space 102. The angle of approach of the person 240 describes an angle, relative to the structure 201, at which the person 240 is moving. The angle of approach can be analyzed to determine whether it is toward or away from the access-controlled interior space 102, and/or to determine whether it corresponds to movement toward a specific opening (e.g., the door 203) of the structure 201, and these and other determinations resulting from analysis of the angle of approach can be considered by the intention detecting function 224.

The intention detecting function 224 may be configured to determine whether the person 240 intends to enter the access-controlled interior space 102 based in part on a speed of approach of the person 240 with respect to the access-controlled interior space 102. For example, user behavior during previous movements near the access-controlled interior space 102 may be used to develop a model that correlates speed of approach to presence or absence of intention to enter and use the access-controlled interior space 102. This model is pre-existing and is available to the intention detecting function 224 prior to the current analysis. The speed of approach of the person 240 may be evaluated using this model and may result in a signal indicative of intention of enter and use the access-controlled interior space 102, such as a positive or negative binary indication, or a score expressing a likelihood that the person 240 possesses a present intention to enter and use the access-controlled interior space 102.

The intention detecting function 224 may be configured to determine whether the person 240 intends to enter the access-controlled interior space 102 by predicting a destination of the trajectory 244 of the person 240. This prediction may be based on the approach angle, the speed of approach, presence of other possible destinations for the person 240 who is located near the access-controlled interior space 102, prior behavior of the person 240, and/or other factors. As an example, the intention detecting function 224 may use information describing possible destinations in the environment 242, and attempt to match the trajectory 244 to one of the possible destinations, which may correspond to the access-controlled interior space 102 (e.g., such as by corresponding to the door 203) or may correspond to locations other than the access-controlled interior space 102.

The intention detecting function 224 may be configured to determine whether the person 240 intends to enter the access-controlled interior space 102 based in part on contextual information obtained from images (e.g., captured by the camera 252), that include the person 240. As an example, the images may be analyzed to identify an object that is carried by the person 240. The identity of that object, optionally in combination with information describing prior behavior, can be used to judge the intention of the person 240. As an example, the person 240 may typically carry a bag when they use the access-controlled interior space 102, and detecting that the person 240 is presently carrying the bag may be considered by the intention detecting function 224 as supporting a likelihood that the person 240 has an intention to use the structure 201. As an example, in a residential setting, the person 240 may carry gardening tools near the access-controlled interior space 102. Use of the access-controlled interior space 102 may be negatively correlated with carrying gardening tools based on prior behavior of the person 240, and as a result, detecting that the person 240 is carrying gardening tools may be interpreted, by the intention detecting function 224, as a signal that the person 240 does not have a present intention to enter and use the access-controlled interior space 102.

Based on previously obtained behavior information, the intention detecting function 224 may model intention based on schedule information. For example, the intention detecting function may determine a likelihood of intention to use the access-controlled interior space 102 of the structure 201 based in part on the day of week and time of day at which the person 240 is located near the access-controlled interior space 102, based on prior behavior by the person 240. Schedule information may be obtained from the user device 104 of from an external service with permission from the person 240.

In some implementations, the intention detecting function 224 is configured to determine whether the person 240 intends to enter the access-controlled interior space 102 based in part on a spoken command that is uttered by the person 240. As an example, the microphone 256 may monitor audible noises that are made near the access-controlled interior space 102. Upon detecting an utterance made by the person 240, the intention detecting function 224 may judge whether that utterance is a spoken command. A spoken command may be an expression, by the person 240, in any spoken form, of an intention to use the access-controlled interior space 102. In some implementations, the spoken command may be a specific predetermined command, phrase, password, or access code that is spoken by the person 240 to indicate their intention to use the access-controlled interior space 102. In other implementations, the spoken command may be a natural language sentence that expresses the intention, and this may be analyzed by the intention detecting function to analyze whether the spoken command conveys an intention to enter and use the access-controlled interior space 102.

In some implementations, the intention detecting function 224 is configured to determine whether the person 240 intends to enter the access-controlled interior space 102 in part on a gesture made by the person 240. The gesture may be perceived, for example, by applying machine vision techniques to images obtained using the camera 252. As an example, the gesture may be a predetermined gesture that the intention detecting function 224 has been programmed to recognize as an expression of intent. As an example, the person 240 may have previously selected a specific gesture that is to be recognized by the intention detecting function 224 as an expression of intent to use the access-controlled interior space 102, and this selection may be stored by the intention detecting function 224, such as in a user profile that is associated with the person 240 and has been made available to the intention detecting function with consent from the person 240.

In some implementations, the intention detecting function 224 is configured to determine whether the person 240 intends to enter the access-controlled interior space 102 based in part on contact, by the person 240, with a portion of the structure 201, such as a surface of the door 203 or a surface near the door 203. This contact may be detected using the touch sensor 258. This contact is determined using sensing modalities that do not utilize a discrete physical structure (e.g., such as a button or a handle) that is provided for the purpose of providing an input or moving a portion of the structure 201 and/or the door 203. Instead, large areas, such as a wall surface or a panel surface, may serve as touchable areas used to express intention to enter the access-controlled interior space 102 of the structure 201, and the person 240 may indicate this intention by tapping the area with a finger, or placing an open hand on the area. As one example, contact with a portion of the structure 201 may be detected using capacitance based touch sensing technologies, such as the touch sensor 258, that are applied to the portion of the structure 201, which may be, for example, an exterior wall surface or panel surface of the structure 201. As another example, video based touch sensing may be implemented using machine vision techniques to analyze images obtained by the camera 252.

In some implementations, the intention detecting function 224 is configured to determine whether the person 240 intends to enter the access-controlled interior space 102 based in part on a command, received from the user device 104, to heat or cool a system of the access-controlled interior space 102. The system may be, for example, a heating or cooling device that is associated with the access-controlled interior space 102 and/or the structure 201. As an example, this command may be transmitted from the user device 104 to the control device 208 using an application that is executed by the user device 104. The communications device 254 may receive the transmission. In response to the command to heat or cool a system of the access-controlled interior space 102, the intention detecting function 224 may correlate the next approach toward the access-controlled interior space 102 by the person 240 as having a very strong likelihood (e.g., one hundred percent) of being associated with an intention to enter and use the access-controlled interior space 102.

The access determining function 226 is configured to receive information from one or more functions of the entry control system 216, and determine whether and how to provide access to the person 240 based on the received information. As examples, the access determining function 226 may receive such information from the proximity detecting function 218, the identity detecting function 220, the authorization determining function 222, and/or the intention detecting function 224.

In one implementation, the access determining function 226 provides access to the access-controlled interior space 102 in response to determining that the person 240 is located near the access-controlled interior space 102, determining that the person 240 is authorized to use the access-controlled interior space 102, and detecting the intention to enter the access-controlled interior space 102. In this example, providing access to the access-controlled interior space 102 may include unlocking the door 203 and/or automatically opening the door 203. As an example, it may be determined by the access determining function 226 that access to the access-controlled interior space 102 should be provided when the person 240 is determined to be within a threshold distance of the access-controlled interior space 102 (e.g., withing a threshold distance of the door 203 of the structure 201), that the person 240 is authorized to use the access-controlled interior space 102, and that the person 240 intends to use the access-controlled interior space 102, for example, based on information from the intention detecting function 224 indicating that a value (e.g., probability value or likelihood score) representing the user's intent to enter and use the access-controlled interior space 102 is above a first threshold value.

Determining the type of access to provide to the person 240 may be based on the information received from the intention detecting function 224. As an example, the access determining function 226 may determine that the door 203 should be unlocked but not automatically opened when the value representing the user's intent to enter and use the access-controlled interior space 102 is above the first threshold value and below a second threshold value. The access determining function 226 may determine that the door 203 of the structure 201 should be automatically opened when the value representing the user's intent to enter and use the access-controlled interior space 102 is above the second threshold value.

In some implementations, the structure 201 includes multiple doors that can be used to access the access-controlled interior space 102, or the structure 201 may include multiple access-controlled interior spaces that have separate doors. In these implementations, unlocking the door 203 or automatically opening the door 203 may include selecting one of the multiple doors to be unlocked and/or opened. A selected one of the doors to be unlocked and/or automatically opened may be selected based on information received by the access determining function 226 by other functions of the entry control system 216. As an example, the identity of the person 240, as determined by the identity detecting function 220, may be used to select the door 203 to be automatically unlocked and/or opened, for example, based on a profile associated with the person 240 indicating which they typically use to enter the access-controlled interior space 102. As another example, the trajectory 244 of the person 240 with respect to the access-controlled interior space 102 may be used to select the door 203 to be automatically unlocked and/or opened, for example, by analyzing the angle of approach of the person 240 with respect to each of the doors 203 or by predicting a destination for the person 240 (as previously described) that corresponds to the door 203 to be unlocked and/or automatically opened. In implementations that include multiple access-controlled interior spaces, the type of space may be used to specify settings that control whether and how access is provided to the person 240, such as by specifying different rules for access to a private office as opposed to a bathroom.

The system 100 and/or the control device 208 may be configured to perform processes in support of providing access to the structure 201. Such processes can be implemented using one or more computing devices, such the computing device 570 of FIG. 5. As an example, the processes described herein and the steps thereof may be implemented in the form of computer program instructions that are executable by one or more computing devices, wherein the instructions, when executed by the one or more computing devices, cause the one or more computing devices to perform functions that correspond to the steps of the processes.

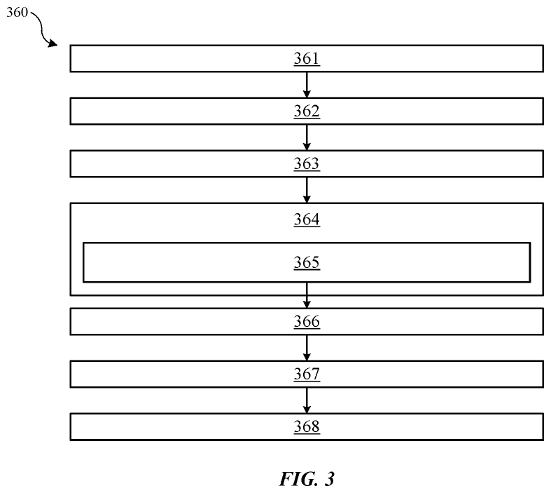

FIG. 3 is a block diagram that shows a process 360 for providing access to the access-controlled interior space 102. The process 360 includes obtaining sensor information, determining that a person is located near the access-controlled interior space 102, determining that the person is authorized to use the access-controlled interior space 102, detecting an intention to enter the access-controlled interior space 102 by the person 240. The process 360 further includes providing access to the access-controlled interior space 102, which is performed in response to determining that the person 240 is located near the access-controlled interior space 102, determining that the person is authorized to use the access-controlled interior space 102, and detecting the intention of the person 240 to enter the access-controlled interior space 102.

In operation 361, sensor information is obtained by access-controlled interior space 102 (e.g., by the control device 208 of the access-controlled interior space 102). As an example, this function may be performed by the entry control system 216 of the control device 208 using one or more sensors from the sensor system 210. For example, the entry control system 216 may request information from the sensor system 210 for use in support of entry control functions. Operation 361 may include obtaining one or more images from the camera 252, receiving a signal transmitted from an external device using the communications device 254, obtaining an audio recording using the microphone 256, and/or sensing contact with a surface (e.g., a surface of the structure 201) using the touch sensor 258. Multiple iterations of operation 361 may be performed in support of the operations of the process 360.

Operation 362 includes determining whether a person, such as the person 240, is located near the access-controlled interior space 102. Operation 362 may be performed in the manner described with respect to the proximity detecting function 218 of the entry control system 216. Operation 362 may be performed using the sensor information that was obtained in operation 361.

Determining that the person 240 is located near the access-controlled interior space 102 may include determining that the person 240 is located within a threshold distance of the access-controlled interior space 102 and/or within a threshold distance of the door 203. This may be performed, for example, using an image from the camera 252 or using a signal from the user device 104 that is carried by the person 240. Determining that the person 240 is located near the access-controlled interior space 102 may include determining that the person 240 is located within a field of view of one or more cameras from the sensor system 210, such as the camera 252. Determining that the person 240 is located near the access-controlled interior space 102 may include receiving a signal from the user device 104 that is associated with the person 240.

In response to determining that the person 240 is located near the access-controlled interior space 102 using the sensor information, further operations can be performed, such as operations 363-368 of the process 360. In response to determining that no person is located near the access-controlled interior space 102, continued iterations of operation 361 and 362 may be performed.

Operation 363 includes determining whether the person 240 is authorized to use the access-controlled interior space 102. This operation may be performed in response to determining that the person 240 is located near the access-controlled interior space 102 in operation 362. Operation 363 may be performed by the entry control system 216 in the manner described with respect to the identity detecting function 220, and is performed using the sensor information obtained as part of operation 361. As an example, the sensor information may include images from the camera 252, and determining the identity of the person 240 may be performed using the images. As an example, the sensor information may include a signal (e.g., containing authentication information) transmitted from the user device 104 carried by the person 240.

In some situations, the identity of the person 240 is determined in operation 363, and this information (e.g., identity information regarding the person 240) may be used in support of further operations of the process 360. In other situations, the identity of the person 240 is not able to be determined based on the information available to the identity detecting function 220, and an indication that the identity of the person 240 is not known may be used in support of other operations of the process 360. Operation 363 is optional, and in some implementations or situations it may be omitted.

Operation 364 includes determining whether the person 240 is authorized to use the access-controlled interior space 102. This operation may be performed in response to determining that the person 240 is located near the access-controlled interior space 102 in operation 362 and may utilize the identity of the person 240, as optionally determined in operation 363, as a basis for determining authorization. Operation 364 may be performed by the entry control system 216 in the manner described with respect to the authorization determining function 222, and is performed using the sensor information obtained as part of operation 361. In some implementations, determining whether the person 240 is authorized to use the access-controlled interior space 102 is performed using the identity of the person 240 as determined in operation 363. The identity of the person 240 can be compared to known authorized users to determine authorization status.

In some implementations, operation 364 includes sub-operation 365, in which determining whether the person 240 is authorized to use the access-controlled interior space 102 includes transmitting, to an authorized user of the access-controlled interior space 102, a request for access to access-controlled interior space 102 may be transmitted to the user device 104 that is associated with the authorized user. The request for access to the access-controlled interior space 102 may include an image obtained by a camera from the sensor system of the user device 104, where the image shows the person 240, in order to allow the authorized user to determine whether to grant or deny access based on their review of the image. Furthermore, if the identity of person 240 was determined in operation 363, it can be transmitted to the authorized user with the request for access. In some implementations, the request for access is only sent upon determining that the person 240 is not authorized to use the access-controlled interior space 102 based on the identity of the person 240, for example when their identity does not correspond to that of a known authorized user or when their identity cannot be determined.

Operation 366 includes detecting whether the person 240 has an intention to enter the access-controlled interior space 102. This operation may be performed in response to determining that the person 240 is located near the access-controlled interior space 102 in operation 362. Operation 366 may be performed by the entry control system 216 in the manner described with respect to the intention detecting function 224, and is performed using the sensor information obtained as part of operation 361.

Detecting the intention to enter the access-controlled interior space 102 in operation 366 may be based in part on the trajectory 244 of the person 240 including the angle of approach of the person 240 with respect to the access-controlled interior space 102 and the speed of approach of the person 240 with respect to the access-controlled interior space 102. Detecting the intention to enter the access-controlled interior space 102 in operation 366 may be based in part on a geolocation of the structure 201. Detecting the intention to enter the access-controlled interior space 102 of the structure 201 in operation 366 may be based in part on a spoken command. Detecting the intention to enter the access-controlled interior space 102 in operation 366 may be based in part on a gesture made by the person 240. Detecting the intention to enter the access-controlled interior space 102 in operation 366 may be based in part on contact by the person 240 with a surface, such as a portion of the structure 201. Detecting the intention to enter the access-controlled interior space 102 in operation 366 may be based in part on a command, received from the user device 104 that is associated with the person 240, to heat or cool a system that is associated with the access-controlled interior space 102 and/or with the structure 201.

Operation 367 includes determining whether to provide access to the access-controlled interior space 102, and operation 368 includes proving access to the access-controlled interior space 102 in response to a positive determination in operation 367. Otherwise, access may be denied. A determination that access to the access-controlled interior space 102 should be provided is, in some implementations, is only performed in response to determining that the person 240 is located near the access-controlled interior space 102 in operation 362, determining that the person 240 is authorized to use the access-controlled interior space 102 in operation 364, and detecting that the person 240 has an intention to enter the access-controlled interior space 102 in operation 366. In such an example, it is determined that access should be provided in operation 367 and access is subsequently provided in operation 368, such as by causing the door 203 to unlock using the locking mechanism 248 and/or move using the door movement mechanism 250. Also, the type of access to provide may be determined in operation 367. Operations 367 and 368 may be performed in accordance with the description of the access determining function 226.

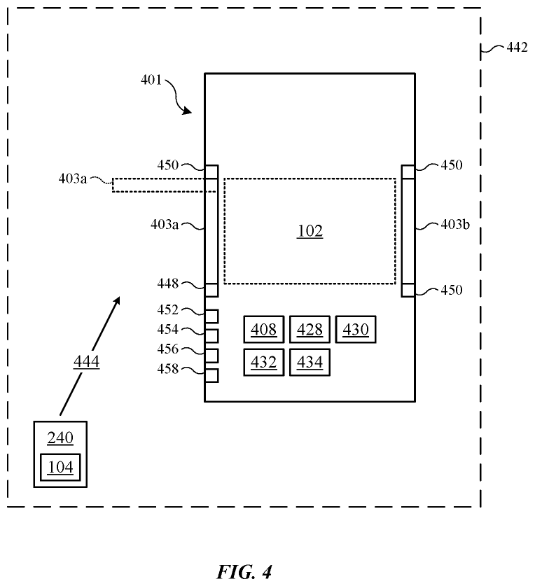

FIG. 4 is a block diagram of a device 401 that defines the access-controlled interior space 102 in an alternative implementation. The device 401 includes components that are equivalent to components of the structure 201, as previously described, including structural components that define the extents of the access-controlled interior space 102 and enclose the access-controlled interior space 102. The device 401 includes a control device 408, which includes the components described with respect to the control device 208, such as the sensor system 210, the HID interface 212, the communications system 214, and the entry control system 216. These components may be specific to the control device 208 or may be shared components that are also used by other systems of the device 401.

The device 401 may be a transportation device having a body that defines the access-controlled interior space 102 in the form of a passenger cabin or cargo area, to which access is provided by a door equivalent to the door 203. As an example, the device 401 may be a vehicle that is supported by wheels relative to an on-road or off-road surface. In support of such functions, the device 401 may include actuator system 428, a navigation system 430, an infotainment system 432, and a drive control system 434.

The actuator system 428 includes one or more actuator components that can accelerate, decelerate, steer, or otherwise cause motion of the device 401. These components can include suspension actuators, steering actuators, braking actuators, and propulsion actuators (e.g., one or more electric motors). The navigation system 430 may include location determining functionality, mapping functionality, and route planning functionality. As an example, the navigation system 430 may include a satellite positing system receiver to determine a current location of the device 401, and may be configured to determine and/or display one or more routes from a current location to a destination including display of geographic areas near the one or more routes.

The infotainment system 432 supports information and entertainment providing functions and may include, as examples, video output devices, audio output devices, and input devices of any type. The infotainment system 432 may allow for selection and playback of audio and video content, as well as display of navigation related information from the navigation system 430. The drive control system 434 is configured to control motion of the device 401, for example, by controlling of operation of actuators from the actuator system 428. The drive control system 434 may implement an autonomous control mode, a manual control mode, and/or a teleoperation control mode. Functions of the drive control system 434 may be supported by the sensor system 210.

In the illustrated implementation, the device 401 includes a first door 403a and a second door 403b, which are equivalent to the door 203 of the structure 201. Each of the first door 403a and the second door 403b may be locked and unlocked by a locking mechanism 448, and each of the first door 403a and the second door 403b may be moved between a closed position and an open position by a door movement mechanism 450, under control of the control device 408. In Implementations in which the intention detecting function 224 determines which door to enter based on the location of the person 240 with respect to the device 401, the determination can include determining whether the person 240 is closer to the first door 403a or the second door 403b, and can include determining whether the trajectory 444 of the person 240 is consistent with travel toward the first door 403a or the second door 403b.

The device 401 may be include a camera 452, a communications device 454, a microphone 456, and a touch sensor 458, which are used by the control device 408 in support of access-control functions and are equivalent to liked-named components described with respect to the structure 201 and the control device 208. The device 401 may be located in an environment 442, such as an outdoor space (e.g., a parking lot) or an indoor space (e.g., a garage having a garage door). The person 240 may be present in the environment 442, and may be moving along a trajectory 444.

Operation of the control device 408 is equivalent to operation of the control device 208, and the process 360 for providing access to the access-controlled interior space 102 may be applied using the device 401 and the control device 408 in the manner previously described with respect to the structure 201 and the control device 208. Determining whether and how to provide access to the access-controlled interior space 102 may further be performed in additional ways that are facilitated by the device 401, as will be explained further herein.

A current location of the device 401 may change in accordance with movement of the device 401, and may be determined by satellite positioning sensors included in the sensor system 210 or may be determined in other ways. Thus, the intention detecting function 224 may be configured to determine whether the person 240 intends to enter the access-controlled interior space 102 based at least in part on a geolocation of the device 401. As an example, stored information may associate specification locations (e.g., identified by geolocation) or types of locations (residence, store, workplace, etc.) with a likelihood that presence near the access-controlled interior space 102 indicates an intention to enter and use the access-controlled interior space 102. This information may be based on past behavior by the person 240 and/or based on past behavior of other users (e.g., aggregated and anonymized user information that does not include personally identifiable information).

Approaching the access-controlled interior space 102 when the device 401 is located in certain locations may be interpreted, by the intention detecting function 224, as a strong signal (e.g., a high likelihood) that indicates an intention, by the person 240, to enter and use the access-controlled interior space 102. Approaching the access-controlled interior space 102 when the device 401 is located in other locations may be a weak signal (e.g., a low likelihood) of a present intention to enter and use the access-controlled interior space 102. Thus, the intention detecting function 224 may be configured to determine whether the person 240 intends to enter the structure 201 based in part on determining a location of the device 401 and identifying a degree of correlation between presence near the access-controlled interior space 102 and intention to use the access-controlled interior space 102 at the particular location (e.g., the current location of the device 401, which may be determined by satellite positioning or other means). For example, the degree of correlation between presence and intent may be high at an office or shopping center but low at a residence. Thus, detecting the intention to enter the access-controlled interior space 102 in operation 366 may be based in part on determining whether the device 401 is located at a particular location that is associated with one of a high correlation between presence and intent to enter, or a low correlation between presence and intent to enter, based on stored information that may be based on previous behavior of the person 240.

In addition, when the device 401 is located in an interior space (e.g., a garage), the intention detecting function 224 may be configured to determine whether a door (e.g., a garage door) is open, and this circumstance may be identified by the intention detecting function 224 as being associated with an increased likelihood that the person 240 intends to enter and use the access-controlled interior space 102, while the door being closed may be identified by the intention detecting function 224 as being associated with a decreased likelihood that the person 240 intends to enter and use the access-controlled interior space 102.

Based on previously obtained behavior information, location may be correlated with schedule information, such as day of week or time of day, and the intention detecting function 224 may model intention based jointly on geolocation and schedule. For example, the intention detecting function 224 may determine a likelihood of intention to use the access-controlled interior space 102 based on day of week and time of day in combination with the current location of the device 401, based on prior behavior by the person 240.

FIG. 5 is a block diagram that shows a computing device 570 according to an example implementation. In the illustrated example, the computing device 570 includes a processor 571, a memory device 572, a storage device 573, input devices 574, a display device 575, and a communication device 576. These and other components may be interconnected by a system bus or other conventional type of interconnect device.

To execute program instructions, the processor 571 may be implemented in the form of one or more conventional processing devices and/or more or more special-purpose processing devices. Implementations may include one or more central processing units, one or more graphics processing units, one or more application specific integrated circuits, and/or one or more field programmable gate arrays. The memory device 572 provides short-term storage in the form of one or more volatile, high-speed, short-term information storage devices, such as random-access memory. Long-term storage of computer program instructions and other data may be provided by the storage device 573, which is a non-volatile information storage device, such as a flash memory, a hard drive, or a solid-state drive. The input devices 574 allow a user to interact with the computing device, and may include a keyboard, a mouse, a touch-based input device, a non-contact gesture-based input device, an audio input device, a motion tracking device, or other type of input device. The display device 575 allows information to be provided by the user and may be implemented using conventional display technologies. The communications device 576 may implement wired and/or wireless communication with other devices through direct or indirect (e.g., networked) connections.

The computing device 570 is operable to store, load, and execute computer program instructions. When executed by the computing device 570, the computer program instructions cause the computing device to perform operations. The operations that can be performed by the computing device 570 may include obtaining information. Examples of obtaining information include accessing the information from a storage device, accessing the information from short-term memory, receiving a wired or wireless transmission that includes the information, receiving signals from an input device that represent user inputs, and receiving signals from sensors that represent observations made by the sensors. The operations that can be performed by the computing device 570 may include making a determination. Examples of making a determination include comparing a value to a threshold, comparing states to conditions, and making a calculation using data of any type. The operations that can be performed by the computing device 570 may also include transmitting information, for example, to a remote system. The operations that can be performed by the computing device 570 may also include outputting a signal to cause an external device to perform an operation. As examples, a computing device 570 may control a component, cause a sensor to take a measurement, cause a camera to capture an image, or cause operation of an actuator in a specified manner.

An aspect of the above-described technology contemplates the use of data available from various sensors and other sources in controlling physical access. While careful authentication is prudent in the context of physical access control, to the extent that implementations of the present technology involve data that uniquely identifies or locates a specific person (or otherwise deemed personal and sensitive), implementers are reminded to comply with applicable privacy policies and/or practices. These policies and practices include those generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity. Such collection and use should occur after receiving the informed consent of the users. Additionally, such entities should consider taking any needed steps for safeguarding and securing access to such personal information data and ensuring that others with access to the personal information data adhere to their privacy policies and procedures.

What is claimed is:

1. A non-transitory computer-readable storage device including program instructions executable by one or more processors that, when executed, cause the one or more processors to perform operations, the operations comprising:
obtaining sensor information from a sensor system, wherein the sensor system senses exterior surroundings of an access-controlled interior space;
determining that a person is located outside an entry to the access-controlled interior space, using the sensor information;
determining that the person is authorized to enter the access-controlled interior space, using the sensor information;
detecting an intention to enter the access-controlled interior space by the person; and
in response to determining that the person is located near the access-controlled interior space, determining that the person is authorized to enter the access-controlled interior space, and detecting the intention to enter the access-controlled interior space, providing access to the access-controlled interior space.

2. The non-transitory computer-readable storage device of claim 1, wherein detecting the intention to enter the access-controlled interior space comprises determining an angle of approach of the person with respect to the access-controlled interior space and a speed of approach of the person with respect to the access controlled interior space.

3. The non-transitory computer-readable storage device of claim 1, wherein detecting the intention to enter the access-controlled interior space comprises determining a geolocation of the access-controlled interior space.

4. The non-transitory computer-readable storage device of claim 1, wherein detecting the intention to enter the access-controlled interior space comprises determining a degree of correlation between presence near the access-controlled interior space and intent to enter the access-controlled interior space according to a current location of the access-controlled interior space.

5. The non-transitory computer-readable storage device of claim 1, wherein detecting the intention to enter the access-controlled interior space comprises detecting a spoken command.

6. The non-transitory computer-readable storage device of claim 1, wherein detecting the intention to enter the access-controlled interior space comprises detecting a gesture made by the person.

7. The non-transitory computer-readable storage device of claim 1, wherein detecting the intention to enter the access-controlled interior space comprises detecting contact with a portion of the access-controlled interior space.

8. The non-transitory computer-readable storage device of claim 1, wherein detecting the intention to enter the access-controlled interior space comprises receiving, from a device associated with the person, a command to heat or cool a system of the access-controlled interior space.

9. An apparatus, comprising:
a memory; and
one or more processors that are configured to execute instructions that are stored in the memory, wherein the instructions, when executed, cause the one or more processors to:
obtain sensor information from a sensor system, wherein the sensor system senses exterior surroundings of an access-controlled interior space;
determine that a person is located outside an entry to the access-controlled interior space, using the sensor information;
determine that the person is authorized to enter the access-controlled interior space, using the sensor information;
detect an intention to enter the access-controlled interior space by the person; and
in response to determining that the person is located near the access-controlled interior space, determine that the person is authorized to enter the access-controlled interior space, and detecting the intention to enter the access-controlled interior space, providing access to the access-controlled interior space.

10. The apparatus of claim 9, wherein detecting the intention to enter the access-controlled interior space comprises determining an angle of approach of the person with respect to the access-controlled interior space and a speed of approach of the person with respect to the access controlled interior space.

11. The apparatus of claim 9, wherein detection of the intention to enter the access-controlled interior space comprises determining a geolocation of the access-controlled interior space.

12. The apparatus of claim 9, wherein detection of the intention to enter the access-controlled interior space comprises determining a degree of correlation between presence near the access-controlled interior space and intent to enter the access-controlled interior space according to a current location of the access-controlled interior space.

13. The apparatus of claim 9, wherein detection of the intention to enter the access-controlled interior space comprises detecting a spoken command.

14. The apparatus of claim 9, wherein detection of the intention to enter the access-controlled interior space comprises detecting a gesture made by the person.

15. The apparatus of claim 9, wherein detection of the intention to enter the access-controlled interior space comprises detecting contact with a portion of the access-controlled interior space.

16. The apparatus of claim 9, wherein detection of the intention to enter the access-controlled interior space comprises receiving, from a device associated with the person, a command to heat or cool a system of the access-controlled interior space.

17. A method, comprising:
obtaining sensor information from a sensor system, wherein the sensor system senses exterior surroundings of an access-controlled interior space;
determining that a person is located outside an entry to the access-controlled interior space, using the sensor information;
determining that the person is authorized to enter the access-controlled interior space, using the sensor information;
detecting an intention to enter the access-controlled interior space by the person; and
in response to determining that the person is located near the access-controlled interior space, determining that the person is authorized to enter the access-controlled interior space, and detecting the intention to enter the access-controlled interior space, providing access to the access-controlled interior space.

18. The method of claim 17, wherein detecting the intention to enter the access-controlled interior space comprises determining an angle of approach of the person with respect to the access-controlled interior space and a speed of approach of the person with respect to the access controlled interior space.

19. The method of claim 17, wherein detecting the intention to enter the access-controlled interior space comprises determining a geolocation of the access-controlled interior space.

20. The method of claim 17, wherein detecting the intention to enter the access-controlled interior space comprises determining a degree of correlation between presence near the access-controlled interior space and intent to enter the access-controlled interior space according to a current location of the access-controlled interior space.
